(19) United States
(12) Patent Application Publication
(10) Pub. No.: US 2019/0323139 A1
(43) Pub. Date: Oct. 24, 2019

(54) SUBSTRATE WITH MATRIX-FREE NANOSTRUCTURED HYDROPHILIC ANALYTE SPOTS FOR USE IN MASS SPECTROMETRY

(71) Applicant: InRedox LLC, Longmont, CO (US)

(72) Inventors: Frank Howland Carpenter, Fort Collins, CO (US); Dmitri Routkevitch, Longmont, CO (US); Michael H.B. Stowell, Boulder, CO (US)

(73) Assignee: InRedox LLC, Longmont, CO (US)

(21) Appl. No.: 16/458,208

(22) Filed: Jul. 1, 2019

Related U.S. Application Data
(63) Continuation-in-part of application No. PCT/US2017/069130, filed on Dec. 29, 2017.
(60) Provisional application No. 62/440,533, filed on Dec. 30, 2016.

(51) Int. Cl. C25D 11/02; C25D 11/32; C25D 11/06; H01J 49/16

(52) U.S. Cl. CPC C25D 11/022; H01J 49/164; C25D 11/06; C25D 11/32

(57) ABSTRACT

The present disclosure describes a matrix-free nanostructured substrate for use in mass spectrometry. The substrate may preferably include one or more localized analyte spots for placement of an analyte, where each analyte spot may comprise a nanostructured metal oxide or semiconductor containing nanotubes or nanopores. The substrate may further include unstructured metal, metal oxide, or semiconductor that is not nanotubular or nanoporous in the part of the substrate that surrounds each of the analyte spots. In some embodiments, the nanostructured metal oxide or semiconductor may be chemically or structurally modified, and the analyte spots may additionally or alternatively include secondary nanostructures such as nanorods, nanoparticles, nanocoatings, or nanotubes. This may facilitate energy transfer to the analyte for matrix-free laser desorption/ionization. The analyte spots may preferably be more hydrophilic than the surrounding part of the substrate to ensure concentration of the analyte at the analyte spots.

### CROSS-REFERENCE TO RELATED APPLICATIONS

This application is a continuation-in-part of PCT Patent Application No. PCT/US2017/069130, filed on Dec. 29, 2017, which claims the benefit of and priority to U.S. Provisional Patent Application Ser. No. 62/440,533, filed on Dec. 30, 2016, the disclosures of which are incorporated herein in their entireties by reference.

### BACKGROUND

### Field of the Invention

This disclosure relates to substrates for use in laser desorption/ionization mass spectrometry (LDI-MS).

### Description of the Related Art

Mass spectrometry (MS) is an analytical technique used to analyze samples according to mass, more specifically by sorting samples according to the mass-to-charge ratio of ionized species. To analyze a sample in a mass spectrometer, the sample must first be converted into gas phase ions by imparting energy to the sample. This may be accomplished using various methods, including laser desorption/ionization (LDI). An analyte is typically prepared for LDI by co-crystallizing the analyte with a matrix of known small organic molecules that are known to absorb electromagnetic radiation of specific wavelengths. Upon exposure to electromagnetic radiation generated by a laser, the small organic molecules absorb at least a portion of the electromagnetic radiation and then transfer at least part of the energy absorbed to the analyte molecules. This results in ionization and/or desorption. This technique is known as matrix assisted laser desorption/ionization (MALDI). MALDI is a generally effective technique for generating gas phase ions for analysis in the mass spectrometer, but it also has several drawbacks. Sample preparation with the matrix is time consuming and cumbersome. Different analytes may require different matrices, and predicting the optimal combinations is often difficult. Additionally, co-crystallization of the analyte with the matrix is often heterogenous rather than uniform, resulting in non-reproducible LDI-MS signals. Moreover, the matrix used for co-crystallization is generally composed of low molecular weight organic compounds. These compounds are visible in the mass spectra of the samples being analyzed. This results in an interference that typically prevents the analysis of species from an analyte below a certain molecular weight cutoff (generally around 700 Daltons). In addition, use of MALDI techniques sometimes results in a signal that is not strong enough for the analyte of interest. On account of these drawbacks, MALDI often produces insufficient signal-to-noise ratio for the analysis of many analyte types, highlighting the need for new LDI solutions.

In addition to addressing the aforementioned drawbacks of MALDI, any new LDI substrate should be practical for use by high volume users of MS instrumentation and sufficiently robust to be stored for an extended period of time—i.e., the substrate should have a reasonably long shelf life. The form factor, namely the proportion of energy transferred by the substrate to the analyte, should readily accommodate common arrangements of analytes using multiple analyte spots on the same substrate, thus allowing use with standard MS instrumentation without requiring an overall change in MS methods. Finally, a practical LDI substrate should be capable of manufacturing at a reasonable cost.

Various efforts have attempted to solve the aforementioned problems. For example, U.S. Pat. Nos. 7,122,792, 7,755,038, 7,858,928, and 8,084,734, and U.S. Patent Application Publication Nos. 2006/0246225 and 2012/0261567 disclose various solutions for the aforementioned limitations of MALDI techniques. However, these solutions are incomplete and the various limitations of the disclosed solutions render them impractical for widespread use as MALDI replacements.

Nanostructured materials offer potential solutions for a variety of problems. U.S. Pat. Nos. 6,359,288, 7,267,859, 7,649,192, and 7,713,849, and U.S. Patent Application Publication No. 2011/0089402 disclose nanowires of various types. U.S. Patent Application Publication No. 2004/0161949 discloses methods of generating nanostructured materials for use in sensor applications and other applications requiring transmission of electrical signals. Various efforts have attempted to use nanostructured materials in mass spectrometry applications. See, e.g., Lo, et al. “Surface-Assisted Laser Desorption/Ionization Mass Spectrometry on Titania Nanotube Arrays,” Mass Spectrom., 2008, 19, 1014-20; Piret, et al. “Surface-Assisted Laser Desorption-Ionization Mass Spectrometry on Titanium Dioxide (TiO₂) Nanotube Layers,” Analyst, 2012, 137, 3058-63; Nitta, et al. “Gold-Decorated Titania Nanotube Arrays as Dual-Functional Platform for Surface-Enhanced Raman Spectroscopy and Surface-Assisted Laser Desorption/Ionization Mass Spectrometry,” Appl. Mater. Interfaces, 2014, 6, 8387-95; Nayak, et al. “Effects of Thin-Film Structural Parameters on Laser Desorption/Ionization from Porous Alumina,” Anal. Chem., 2007, 79, 4950-56; Sen, et al. “Use of Nanoporous Alumina Surface for Desorption Electrospray Ionization Mass Spectrometry in Proteomic Analysis,” Biomed. Microdevices, 2008, 10, 531-38; Okuno, et al. “Requirements for Laser Induced Desorption Ionization on Submicrometer Structures,” Anal. Chem., 2005, 77, 5364-69; Wada, et al. “Ordered Porous Alumina Geometries and Surface Metals for Surface-Assisted Laser Desorption/Ionization of Biomolecules: Possible Mechanistic Implications of Metal Surface Melting,” Anal. Chem., 2007, 79, 9122-27. However, none of these efforts have generated a nanostructured LDI substrate that is practical for widespread use in high volume laboratories.

Thus, there remains a need for new matrix-free substrates for the introduction of samples into a mass spectrometer using LDI that require minimal sample preparation, generate reproducible analyte signals, do not interfere with analysis of low molecular weight constituents of a target sample, provide adequate signal intensity, have an adequate shelf life and form factors that accommodate multiple samples per substrate, and may be manufactured at low cost.

### SUMMARY

The present disclosure describes a matrix-free nanostructured substrate for use in mass spectrometry (MS). The substrate may preferably include one or more localized analyte spots configured for placement of an analyte thereon and/or therein, where each analyte spot may comprise a nanostructured metal oxide or semiconductor containing nanotubes or nanopores. The substrate may preferably further include unstructured metal, metal oxide, or semiconductor that is not nanotubular or nanoporous in the part of the substrate that surrounds each of the localized analyte spots. The nanotubes or nanopores of the nanostructured metal oxide or semiconductor are described herein as primary nanostructures, and these primary nanostructures are localized in a defined pattern and are what differentiate the analyte spots from the surrounding substrate. In some embodiments, the nanostructured metal oxide or semiconductor of the analyte spots may be chemically or structurally modified, and the localized analyte spots may additionally or alternatively comprise one or more other materials. The modifications or additional materials may include but are not limited to secondary nanostructures such as nanorods, nanoparticles, nanocoatings, or nanotubes. The modifications or additional materials may preferably facilitate energy transfer to the analyte for laser desorption/ionization (LDI) of an analyte without a co-crystallizing matrix. The analyte spots may preferably be more hydrophilic than the surrounding part of the substrate. An aliquot of an analyte solution may be placed on and/or within the analyte spots by pipetting, printing, adsorption, deposition, or any other suitable method of placing a small quantity of the analyte on and/or within the analyte spots. The analyte solution may preferably be hydrophilic. The hydrophilicity of the localized analyte spots ensures that the analyte will be confined and concentrated within the analyte spots, even if the aliquot of the analyte solution is initially in contact only with a portion of the analyte spot, thereby preventing non-uniform distribution of the analyte that would be detrimental to MS signal reproducibility. The one or more localized analyte spots may preferably be configured to form an array, wherein the array comprises at least two analyte spots and at least one row and two columns of analyte spots arranged in a regular pattern. The uniform distribution of the concentrated analyte in the localized nanostructured analyte spot, as described herein, leads to improvements in MS signal reproducibility and intensity.

In some preferred embodiments, the primary substrate material is titanium or aluminum, and the localized analyte spots are nanotubular anodic titanium oxide or nanoporous anodic aluminum oxide, respectively.

In some preferred embodiments, the primary substrate material is silicon, and the localized analyte spots are nanoporous silicon.

In some preferred embodiments, a semiconductor or metal is deposited in the nanotubes or nanopores of the localized analyte spots to form secondary nanostructures, including but not limited to nanoparticles, nanorods, continuous or discontinuous nanocoatings, or nanotubes. These secondary nanostructures facilitate energy transfer to an analyte placed on or within an analyte spot and thereby facilitate LDI of an analyte confined within the primary nanostructures within the analyte spot.

In some preferred embodiments, the analyte spots include sections with different types of secondary nanostructures within a given analyte spot. This facilitates LDI of complex analyte mixtures that may contain various species of very different molecular size that require different nanostructures for effective LDI.

In some preferred embodiments, some analyte spots contain certain types of secondary nanostructures, such as nanoparticles, nanorods, nanocoatings, or nanotubes, while other analyte spots contain either different types of secondary nanostructures, such as nanoparticles, nanorods, nanocoatings, or nanotubes, or contain no secondary nanostructures or deposits at all.

### BRIEF DESCRIPTION OF THE DRAWINGS

FIG. 1 shows a top view of a substrate with 96 analyte spots in a substrate base.

FIG. 2 shows a side view of a single analyte spot.

FIG. 3 shows a side view of a single analyte spot containing nanorods within the nanotubes or nanopores of the analyte spot.

FIG. 4 shows a side view of a single analyte spot containing nanorods within the nanotubes or nanopores of the analyte spot.

FIG. 5 shows a side view of a single analyte spot containing nanotubes within the nanotubes or nanopores of the analyte spot.

FIG. 6 shows a side view of a single analyte spot with a continuous or discontinuous nanocoating conformally coating both the top surface and the inside surfaces of the nanopores or nanotubes of the analyte spot.

FIG. 7 shows a side view of a single analyte spot containing nanoparticles within the nanotubes or nanopores of the analyte spot.

FIG. 8 shows a side view of a single analyte spot containing nanotubes within the nanotubes or nanopores of the analyte spot and containing nanoparticles within the nanotubes contained within the nanotubes or nanopores of the analyte spot.

FIG. 9 shows a top view of a single analyte spot which includes three areas respectively containing no secondary nanostructures, secondary nanorods, and secondary nanoparticles.

FIG. 10 shows a comparison between a MALDI mass spectrum and a mass spectrum obtained using an embodiment of the matrix-free nanostructured substrate disclosed herein.

FIG. 11 shows a scanning electron micrograph of an analyte spot prepared according to EXAMPLE 1.

FIG. 12 shows a scanning electron micrograph of an analyte spot prepared according to EXAMPLE 2.

FIG. 13 shows a scanning electron micrograph of an analyte spot prepared according to EXAMPLE 5.

FIG. 14 shows a scanning electron micrograph of an analyte spot prepared according to EXAMPLE 7.

### DETAILED DESCRIPTION OF THE ILLUSTRATED EMBODIMENTS

The present disclosure describes a matrix-free nanostructured substrate for use in mass spectrometry (MS). The substrate may preferably include one or more localized analyte spots configured for placement of an analyte thereon and/or therein, where each analyte spot may comprise a nanostructured metal oxide or semiconductor containing nanotubes or nanopores. The substrate may preferably further include unstructured metal, metal oxide, or semiconductor that is not nanotubular or nanoporous in the part of the substrate that surrounds each of the localized analyte spots. The nanotubes or nanopores of the nanostructured metal oxide or semiconductor are described herein as primary nanostructures, and these primary nanostructures are localized in a defined pattern and are what differentiate the analyte spots from the surrounding substrate. In some embodiments, the nanostructured metal oxide or semiconductor of the analyte spots may be chemically or structurally modified, and the localized analyte spots may additionally or alternatively comprise one or more other materials. The modifications or additional materials may include but are not limited to secondary nanostructures such as nanorods, nanoparticles, nanocoatings, or nanotubes. The modifications or additional materials may preferably facilitate energy transfer to the analyte for laser desorption/ionization (LDI) of an analyte without a co-crystallizing matrix. The analyte spots may preferably be more hydrophilic than the surrounding part of the substrate. An aliquot of an analyte solution may be placed on and/or within the analyte spots by pipetting, printing, adsorption, deposition, or any other suitable method of placing a small quantity of the analyte on and/or within the analyte spots. The analyte solution may preferably be hydrophilic. The hydrophilicity of the localized analyte spots ensures that the analyte will be confined and concentrated within the analyte spots, even if the aliquot of the analyte solution is initially in contact only with a portion of the analyte spot, thereby preventing non-uniform distribution of the analyte that would be detrimental to MS signal reproducibility. The one or more localized analyte spots may preferably be configured to form an array, wherein the array comprises at least two analyte spots and at least one row and two columns of analyte spots arranged in a regular pattern. The uniform distribution of the concentrated analyte in the localized nanostructured analyte spot, as described herein, leads to improvements in MS signal reproducibility and intensity.

In some preferred embodiments, the primary substrate material is titanium or aluminum, and the localized analyte spots are nanotubular anodic titanium oxide or nanoporous anodic aluminum oxide, respectively.

In some preferred embodiments, the primary substrate material is silicon, and the localized analyte spots are nanoporous silicon.

In some preferred embodiments, a semiconductor or metal is deposited in the nanotubes or nanopores of the localized analyte spots to form secondary nanostructures, including but not limited to nanoparticles, nanorods, continuous or discontinuous nanocoatings, or nanotubes. These secondary nanostructures facilitate energy transfer to an analyte placed on or within an analyte spot and thereby facilitate LDI of an analyte confined within the primary nanostructures within the analyte spot.

In some preferred embodiments, the analyte spots include sections with different types of secondary nanostructures within a given analyte spot. This facilitates LDI of complex analyte mixtures that may contain various species of very different molecular size that require different nanostructures for effective LDI.

In some preferred embodiments, some analyte spots contain certain types of secondary nanostructures, such as nanoparticles, nanorods, nanocoatings, or nanotubes, while other analyte spots contain either different types of secondary nanostructures, such as nanoparticles, nanorods, nanocoatings, or nanotubes, or contain no secondary nanostructures or deposits at all.

The disclosed LDI substrate may preferably be prepared according to the following method:
(1) an LDI substrate base is obtained;
(2) the LDI substrate base is patterned using a mask to define LDI analyte spots of a desired shape and size, generating a patterned LDI substrate;
(3) the patterned LDI substrate is anodized to form localized nanostructured LDI analyte spots to generate a patterned and anodized LDI substrate;
(4) the mask is removed; and
(5) the patterned and anodized LDI substrate is optionally subjected to additional procedures to improve functionality and performance, either before or after removing the mask.
   The resulting LDI substrate comprises one or more localized analyte spots and a substrate base. The LDI substrate may preferably comprise an array of at least two analyte spots and at least one row and two columns of analyte spots arranged in a regular pattern on the substrate base. In some preferred embodiments, the array may comprise at least 8 rows and at least 12 columns of analyte spots arranged in a regular pattern on the substrate base. In some other preferred embodiments, the array may comprise at least 12 rows and at least 8 columns of analyte spots arranged in a regular pattern on the substrate base.

### LDI Substrate Base

The LDI substrate may use any suitable base that may be patterned and processed according to the procedures below to generate a matrix-free LDI substrate containing one or more localized nanostructured LDI analyte spots.

In some embodiments, the LDI substrate may use a metal sheet as a base. The metal sheet may preferably comprise a metal selected from the group consisting of titanium or aluminum. The metal sheet may preferably comprise a high purity metal of at least 99% purity. More preferably, the metal sheet may be a metal foil.

In other embodiments, the LDI substrate may use a semiconductor wafer as a base. The base may be a silicon wafer, preferably an n-type or p-type silicon wafer, even more preferably a p-type silicon wafer.

In other embodiments, the LDI substrate may use a metal or semiconductor film deposited onto a flat surface as a base. The flat surface may be a glass, metal, or silicon surface. The film may preferably be a metal film comprising a metal selected from the group consisting of titanium and aluminum, and the flat surface may preferably be a metal surface comprising a metal that is different from the metal that comprises the metal film.

### Patterning of LDI Substrate Base

The LDI substrate base may be patterned using a mask to define LDI analyte spots of a desired shape and size using known patterning procedures, thereby generating a patterned LDI substrate.

In some embodiments, the LDI substrate base may be patterned using photolithography. The photolithography procedure may use standard wet or dry photoresists. The photoresist may be applied to the LDI substrate base according to standard procedures familiar to those skilled in the art. Such procedures include application of a photomask, exposure to ultraviolet light, development according to procedures set forth by the photoresist manufacturer, and rinsing in water. The photoresist pattern may preferably be heated to a temperature between about 75° C. and 200° C., more preferably between about 100° C. and 175° C.

In other embodiments, the LDI substrate base may be patterned by applying an insulating tape with a pattern precut into the tape.

In other embodiments, the LDI substrate base may be patterned by applying an insulating mask via screen-printing.

In other embodiments, the LDI substrate base may be patterned by applying an insulating mask via imprint stamp.

In other embodiments, the LDI substrate base may be patterned by applying a thin film to the LDI substrate base and then ablating the thin film using a laser.

The shape and size of the localized LDI analyte spots is defined by the shape and size of the opening in the pattern. Thus the LDI analyte spots may be of almost any size and shape.

In some preferred embodiments, the openings in the mask that define the analyte spots may preferably have an approximately circular shape with a diameter of between 0.1 mm and 10 mm, more preferably between 0.2 mm and 5 mm.

In other embodiments, the openings in the mask that define the LDI analyte spots are non-circular, such as but not limited to substantially rectangular, substantially square, substantially triangular, substantially hexagonal, substantially octagonal, or other related geometries. The diameter of openings in the mask that define LDI analyte spots with non-circular geometry is defined as the maximum width across the surface of the LDI analyte spots.

In some embodiments, an adhesion layer may be formed on the LDI substrate base using electrochemical or thermal oxidation to form a thin layer of oxide on the surface of the LDI substrate base prior to application of the pattern.

### Anodization of Patterned LDI Substrate

The patterned LDI substrate may be anodized to form localized nanostructured LDI analyte spots to generate a patterned and anodized LDI substrate. The depth of the LDI analyte spots is essentially equal to the length of the nanopores or nanotubes formed during anodization. The nanopores or nanotubes formed during anodization are what distinguish the analyte spots from the surrounding substrate base, and are described herein as primary nanostructures.

The anodization procedure may preferably involve at least two anodization steps. The first anodization step may preferably involve formation and subsequent removal of a sacrificial layer, leaving a surface that is nanostructured and ready for a second anodization step. The electrolyte solution and specific anodization procedures will depend on the type of LDI substrate base used.

If the LDI substrate base is aluminum, the electrolyte may preferably be any suitable electrolyte used for creating nanoporous anodic aluminum oxide, including aqueous solutions of poly-protic acids, preferably phosphoric acid, sulfuric acid, or oxalic acid. One preferred electrolyte is 0.3M oxalic acid in water at 12° C. The anodization voltage may preferably be between 5V and 200V, more preferably between 20V and 150V. The first anodization time may preferably be between 1 and 10 hours. In some preferred embodiments, the first anodization forms a sacrificial layer of nanoporous aluminum oxide, which may be removed using a selective oxide etch such as a solution of between 20 and 200 g/L chromic oxide (CrO₃) and between 50 and 500 g/L of phosphoric acid (H₃PO₄) in water at a temperature between 20° C. and 100° C., more preferably between 50° C. and 85° C., for about 5 to 60 min, followed by rinsing in water. The second anodization may be performed at any voltage, more preferably at the same voltage as the first anodization, for a time of between about 2 minutes and 10 hours, depending on the desired depth of the nanopores, followed by rinsing in water. In some preferred embodiments, if the LDI analyte spots are desired to contain electrodeposited metal, the anodization voltage may be gradually reduced at the end of the anodization, more preferably followed by partial etching of the nanoporous aluminum oxide in a solution of 0.05M to 3M H₃PO₄, at a temperature of between about 25° C. to 75° C., more preferably 0.1M to 0.5M H₃PO₄ at between about 25° C. to 50° C., in order to reduce the thickness of the dense oxide layer at the bottom of the nanopores to facilitate electrodeposition.

If the LDI substrate base is titanium, the electrolyte solution may preferably be a solution of a fluoride salt or hydrofluoric acid (HF) in ethylene glycol or glycerin, with a small amount of water optionally also present in some variants. One preferable electrolyte solution is 0.3 wt. % NH₄F and 2 wt. % water in ethylene glycol at room temperature. Other fluoride salts such as NaF or KF may alternatively be used. The first anodization voltage may preferably be between 15V and 200V, and the first anodization time may preferably be between 1 and 10 hours, depending on the desired thickness of nanotubular titanium oxide (TiO₂) to be generated. After anodization, the substrate may be rinsed in water. In some preferred embodiments, after the first anodization, the LDI substrate is sonicated in a 0.1M solution of sulfuric acid (H₂SO₄) to remove the first sacrificial layer of nanotubular TiO₂ and is subsequently rinsed and dried. The second anodization may be performed at any voltage in any suitable electrolyte, more preferably at the same voltage and the same electrolyte as the first anodization, for a time between about 2 minutes and 2 hours, depending on the desired depth of the nanotubes, followed by rinsing and drying. In some preferred embodiments, the rinsing of nanotubular TiO₂ may be performed by first soaking in the anodization electrolyte without fluoride-containing compounds present, followed by rinsing with ethylene glycol, ethanol, and water, and then drying.

If the LDI substrate base is silicon, the electrolyte solution used for anodization may preferably be a solution comprising a fluoride salt or hydrofluoric acid (HF), ethylene glycol, ethanol, and water. Anodization may be performed at a constant current between about 1 mA/cm² to 300 mA/cm², preferably between about about 5 mA/cm² to 30 mA/cm², with or without backside illumination. The size and depth of the pores may be varied by varying the silicon doping, electrolyte concentrations, current density, and duration of anodization. In other preferred embodiments, nanopores may be formed in the silicon substrate base using chemical etching, preferably with the assistance of a metal catalyst, preferably silver or gold, applied to the silicon surface prior to etching. The etching solution may comprise a fluoride salt or hydrofluoric acid (HF), or another strong acid, and an oxidizing agent such as nitric acid (HNO₃) or hydrogen peroxide (H₂O₂). In some embodiments, chemical etching may be followed by a metal etching step to remove residual metal catalyst. After anodization or chemical etching, the LDI substrate is rinsed in water and dried.

The primary nanostructures, namely the nanoporous or nanotubular metal oxide or nanoporous semiconductor generated by the anodization procedure, may preferably comprise nanopores or nanotubes with a diameter of between about 1 nm and 1000 nm, more preferably between about 10 nm and 250 nm, and a length of between about 10 nm and 10 μm, more preferably between about 250 nm and 2 μm.

The ratio of the length to the diameter of primary nanostructures may preferably be between 20:1 and 1:1, more preferably between 10:1 and 2:1, and most preferably between 7:1 and 4:1 for best results.

### Removal of Mask

After the patterned LDI substrate is anodized to form localized nanostructured LDI analyte spots to generate a patterned and anodized LDI substrate, the mask applied for patterning may be removed using standard techniques. One preferred method of removing a photoresist pattern is by soaking in an appropriate organic solvent, such as isopropanol, methyl ethyl ketone, or acetone, as specified by the manufacturer of the photoresist that is used. If a tape mask is used for patterning, it may preferably be mechanically removed by peeling it off.

### Optional Procedures

The patterned and anodized LDI substrate may be ready to use upon removal of the mask or may alternatively be subjected to additional procedures to improve functionality and performance. The additional procedures include but are not limited to deposition of one or more metals, metal alloys, metal oxides, or semiconductors inside the primary nanostructures of anodized LDI analyte spots; increasing the diameter of nanostructures; increasing the exposed surface area of metals, metal alloys, metal oxides, or semiconductors deposited inside the primary nanostructures; and annealing.

In some embodiments, one or more metals or metal alloys may be deposited inside the primary nanostructures, namely the nanopores or nanotubes of localized LDI analyte spots, to form nanoparticles or nanorods at the bottom of the primary nanostructures or to form nanocoatings or secondary nanotubes on the walls of the primary nanostructures. The metal or metal alloy may be any plasmonic metal or alloy thereof, preferably selected from the group consisting of copper, gold, silver, cobalt, and nickel, and alloys thereof, and more preferably selected from the group consisting of copper, silver, gold, and alloys thereof. Metals with comparatively lower melting points, such as copper, silver, and gold, are most suitable for absorbing the incident electromagnetic radiation generated by the laser and subsequently transferring the absorbed energy to the analyte. The metal absorbs and transfers energy; since transmission of electrical signals is not required, optimizing the electronic properties of the analyte spots is unnecessary. Moreover, while the deposition of metals with comparatively lower melting points may decrease the long-term stability of the analyte spots after exposure to incident electromagnetic radiation generated by the laser, the disclosed substrates are not likely to be reused for a second LDI of a second analyte after the first use for LDI of a first analyte, and thus post-LDI long-term stability is not required. Nanoparticles or nanorods deposited at the bottom of the primary nanostructures may preferably only partially fill the primary nanostructures or may alternatively completely fill the primary nanostructures. Nanocoatings or secondary nanotubes formed on the walls of the primary nanostructures may preferably form on some but not all of the wall surface area of the primary nanostructures, thus forming discontinuous structures, or may alternatively form on all of the wall surface area of the primary nanostructures, thus forming continuous structures.

In other embodiments, metal oxides or semiconductors may be deposited inside the primary nanostructures to form nanoparticles or nanorods at the bottom of the primary nanostructures or to form nanocoatings or nanotubes on the walls of the primary nanostructures. Nanoparticles or nanorods deposited at the bottom of the primary nanostructures may preferably only partially fill the primary nanostructures or may alternatively completely fill the primary nanostructures. Nanocoatings or secondary nanotubes formed on the walls of the primary nanostructures may preferably form on some but not all of the wall surface area of the primary nanostructures, thus forming discontinuous structures, or may alternatively form on all of the wall surface area of the primary nanostructures, thus forming continuous structures.

The combination of consecutive or concurrent deposition processes may also be used to create complex structures.

In some preferred embodiments, metal is deposited inside the primary nanostructures of localized LDI analyte spots using electrochemical deposition using a standard electrodeposition solution, typically comprising metal salts, complexing agents, organic and inorganic acids, and other optional additives. For example, copper may be deposited using a solution of 0.1M to 1M CuSO₄ and 0M to 0.5M H₂SO₄ in water. Gold may be deposited using an aqueous solution comprising 12 g/L of KAu(CN)₂ and 100 g/L of citric acid. The resulting metal secondary nanostructures have a diameter approximately equivalent to the inner diameter of the primary nanopores or nanotubes of the localized LDI analyte spots.

In other embodiments, a metal or semiconductor coating is deposited into the primary nanostructures of localized LDI analyte spots using electroless deposition. The deposition of metal may be performed by immersing the LDI substrate into a solution comprising metal compounds and a reducing agent, using one of many available formulations suitable for this purpose. For example, to deposit copper, a solution comprising copper(II) sulfate or copper(II) chloride and reducing agents such as borohydride, formaldehyde, titanium(III) chloride, or other reducing agents may be used. To deposit silver, a solution comprising silver(I) nitrate and a reducing agent such as formaldehyde or glucose may be used. To deposit gold, a solution comprising gold (III) salts and reducing agents such as borohydride may be used.

In other embodiments, metal or semiconductor nanoparticles may be deposited into the primary nanostructures of localized LDI analyte spots by applying a colloidal suspension of metal or semiconductor nanoparticles on the surface of the LDI analyte spots, followed by drying and optional annealing.

In other embodiments, a metal or semiconductor may be deposited inside the primary nanostructures of localized LDI analyte spots by applying a soluble metal or semiconductor compound (such as metal or semiconductor chlorides, acetates, nitrates, and others) to the surface of the LDI analyte spot, followed by drying and annealing in air or in a reducing atmosphere, such as 1 to 10% hydrogen in an inert gas.

In yet other embodiments, a metal or semiconductor may be deposited into the primary nanostructures of localized LDI analyte spots using well-known atomic layer deposition (ALD) processes to generate uniform and conformal, continuous or discontinuous, layers on the walls of the high aspect ratio primary nanostructures. Some of the materials that may be deposited by ALD include gold, silver, copper, nickel, cobalt, platinum, zinc oxide, titanium oxide, and other metals, semimetals, and semiconductors, and their respective oxides and nitrides, and are preferably selected from the group consisting of gold, silver, copper, and alloys thereof. The thickness of the coatings may be between the thickness of a single atomic layer and 100 nm, preferably between 1 nm and 20 nm.

In some embodiments, the inner diameter of the primary nanostructures may be increased and, in some preferred embodiments, a greater surface area of metal, metal alloy, metal oxide, or semiconductor secondary nanostructures deposited inside the pores of the primary nanostructures may be exposed, by performing partial etching of the metal oxide or semiconductor from the pore walls of the primary nanostructures of the LDI analyte spots. For aluminum oxide LDI analyte spots, this may performed by immersing the LDI substrate into a solution comprising 0.1M to 1M H₃PO₄, preferably 0.5M to 1M H₃PO₄, at a temperature between about 25° C. and 75° C., preferably between about 25° C. and 45° C., for between about 1 minute and 200 minutes, depending on the desired increase in the primary nanopore diameter. For the titanium oxide LDI analyte spots, this may be performed by immersing the LDI substrate into a solution comprising 0.1M to 1M HF at 20 to 50° C. for between about 1 minute and 50 minutes, depending on the desired increase of the inner diameter of the primary nanotubes. In some preferred embodiments, the oxide layer is removed almost completely, so that the metal or semiconductor nanorods, nanotubes, nanocoatings, or nanoparticles of the secondary nanostructures are almost completely exposed.

In some embodiments, the LDI substrate may be annealed following anodization or following deposition of one or more metals, metal alloys, metal oxides, or semiconductors as secondary nanostructures into the primary nanostructures of the LDI analyte spots. The annealing may preferably be performed for a duration of between about 10 minutes and 10 hours, more preferably between about 30 minutes and 300 minutes. The annealing temperature may preferably be between about 50° C. and 1250° C., more preferably between about 100° C. and 800° C.

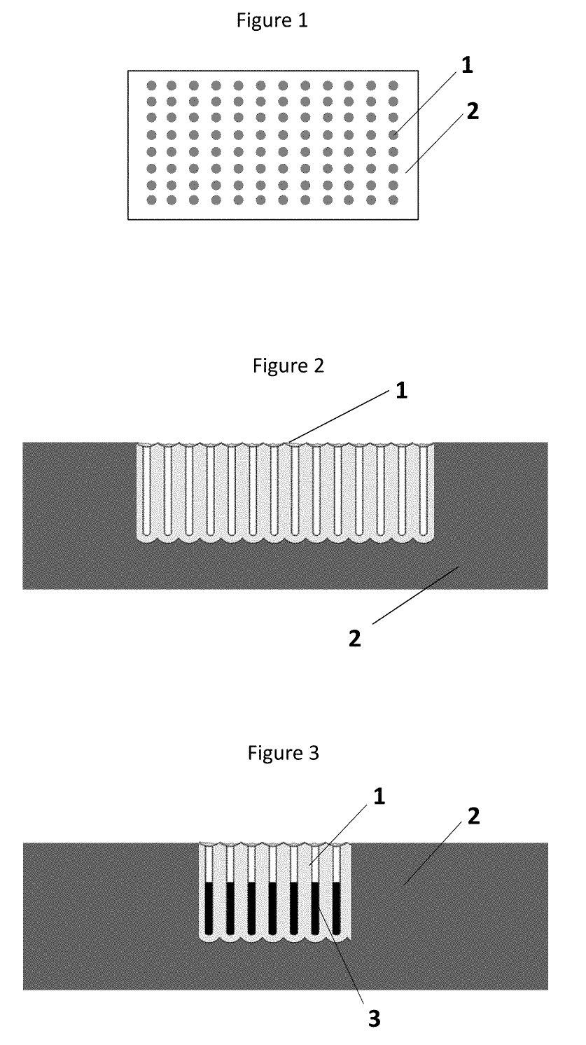

FIG. 1 shows a top view of a substrate with 96 Analyte Spots 1 and a Substrate Base 2. Analyte spots 1 may comprise nanoporous aluminum oxide, nanotubular titanium oxide, or nanoporous silicon. Analyte Spots 1 may optionally further contain secondary nanostructures comprising metal nanoparticles, nanorods, nanocoatings, or secondary nanotubes within the nanoporous or nanotubular metal oxides or nanoporous silicon. Nonporous, non-nanotubular Substrate Base 2 surrounds the analyte spots. Substrate Base 2 may be a metal such as aluminum or titanium, or may be a semiconductor such as silicon. Substrate Base 2 may optionally be coated by a thin layer of an oxide. Analyte Spots 1 are more hydrophilic than the surrounding Substrate Base 2, thereby preventing an analyte placed onto the analyte spots from significantly spreading into Substrate Base 2.

Since a single analyte spot contains many more nanopores or nanotubes than is practical to depict, FIGS. 2-8 discussed below are not drawn to scale.

FIG. 2 shows a side view of a single analyte spot. Substrate Base 2 is not nanostructured and may optionally be coated with a thin layer of oxide.

FIG. 3 shows a side view of a single analyte spot. Nanoporous Al₂O₃, nanotubular TiO₂, or nanoporous Si in Analyte Spot 1 penetrates into Substrate Base 2 for a certain depth perpendicular to the surface of the substrate. Substrate Base 2 is not nanostructured and may optionally be coated with a thin layer of oxide. Secondary Nanorods 3 are contained within the primary nanopores or nanotubes of Analyte Spot 1. The diameter of secondary Nanorods 3 is substantially equal to the inner diameter of the primary nanopores or nanotubes.

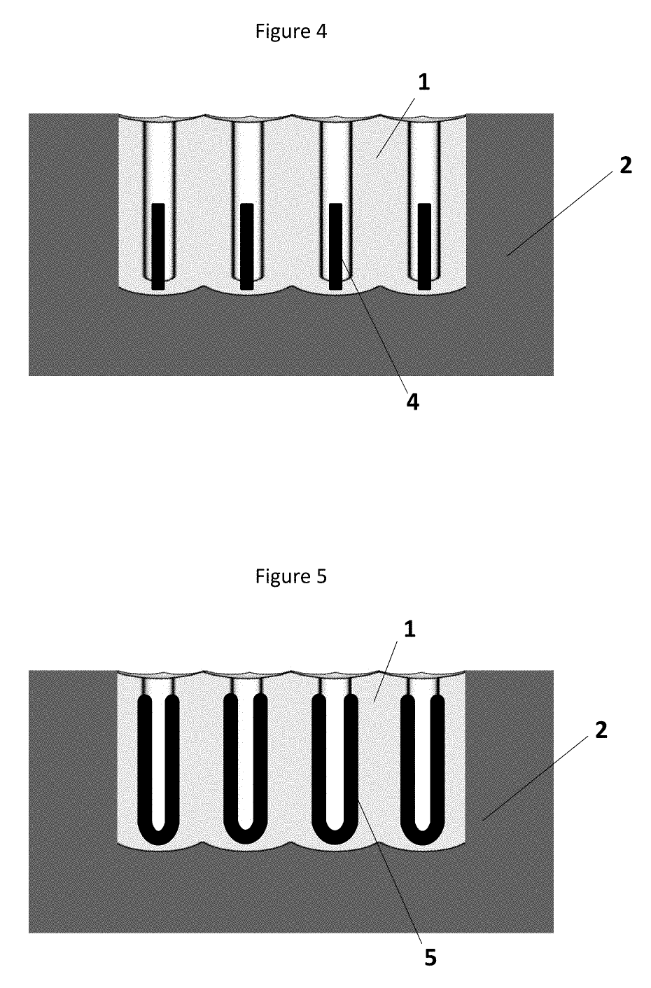

FIG. 4 shows a side view of a single analyte spot. Nanoporous Al₂O₃, nanotubular TiO₂, or nanoporous Si in Analyte Spot 1 penetrates into Substrate Base 2 for a certain depth perpendicular to the surface of the substrate. Substrate Base 2 is not nanostructured and may optionally be coated with a thin layer of oxide. Secondary Nanorods 4 are contained within the primary nanopores or nanotubes of Analyte Spot 1. The diameter of primary nanopores or nanotubes in Analyte Spot 1 has been increased by etching after the deposition of secondary Nanorods 4, so that substantially greater area of the secondary Nanorods 4 is exposed.

FIG. 5 shows a side view of a single analyte spot. Nanoporous Al₂O₃, nanotubular TiO₂, or nanoporous Si in Analyte Spot 1 penetrates into Substrate Base 2 for a certain depth perpendicular to the surface of the substrate. Substrate Base 2 is not nanostructured and may optionally be coated with a thin layer of oxide. Secondary Nanotubes 5 are contained within the primary nanopores or nanotubes of Analyte Spot 1.

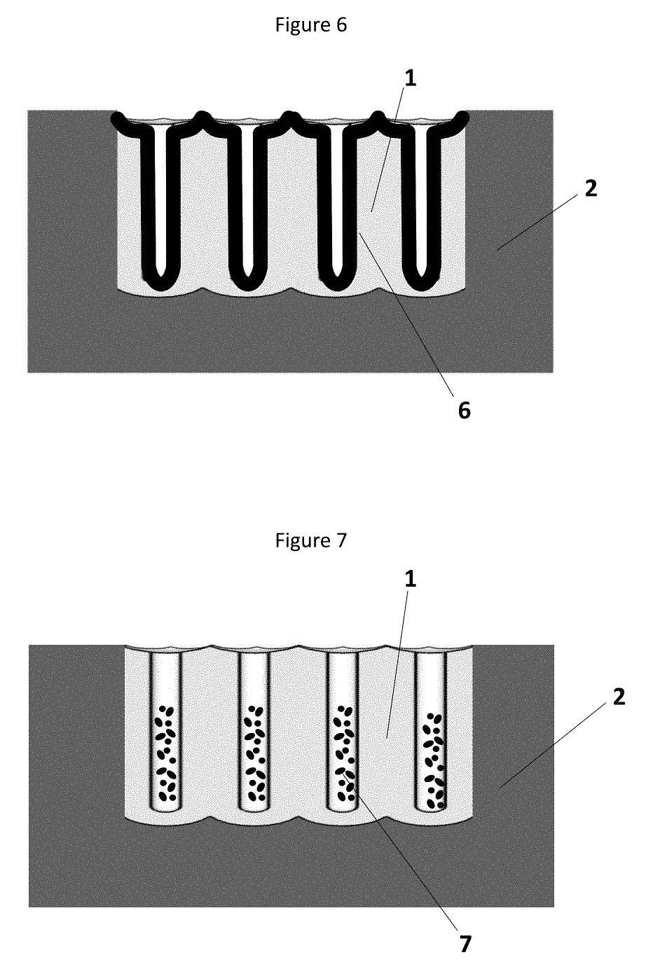

FIG. 6 shows a side view of a single analyte spot. Nanoporous Al₂O₃, nanotubular TiO₂, or nanoporous Si in Analyte Spot 1 penetrates into Substrate Base 2 for a certain depth perpendicular to the surface of the substrate. Substrate Base 2 is not nanostructured and may optionally be coated with a thin layer of oxide. Continuous or discontinuous secondary Nanocoating 6 conformally coats both the surface and the primary nanopores or nanotubes of Analyte Spot 1.

FIG. 7 shows a side view of a single analyte spot. Nanoporous Al₂O₃, nanotubular TiO₂, or nanoporous Si in Analyte Spot 1 penetrates into Substrate Base 2 for a certain depth perpendicular to the surface of the substrate. Substrate Base 2 is not nanostructured and may optionally be coated with a thin layer of oxide. Secondary Nanoparticles 7 are formed inside and/or on the surface of the primary nanopores or nanotubes of Analyte Spot 1.

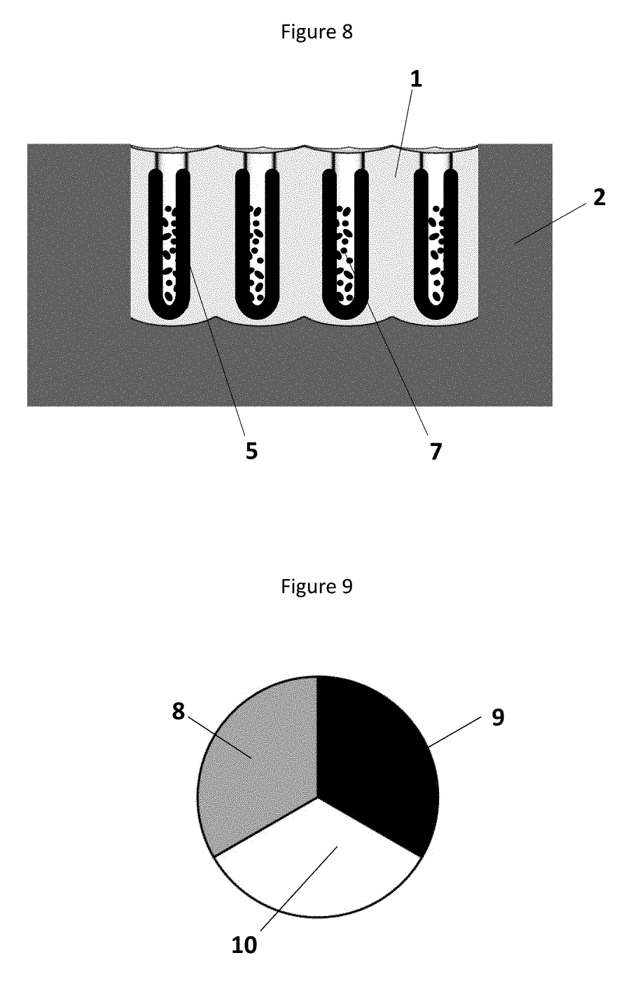

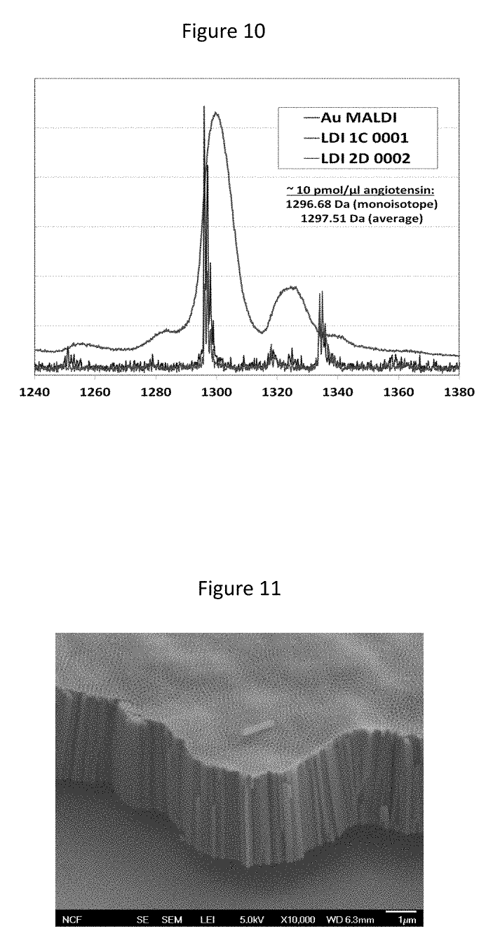

FIG. 8 shows a side view of a single analyte spot. Nanoporous Al₂O₃, nanotubular TiO₂, or nanoporous Si in Analyte Spot 1 penetrates into Substrate Base 2 for a certain depth perpendicular to the surface of the substrate. Substrate Base 2 is not nanostructured and may optionally be coated with a thin layer of oxide. Secondary Nanotubes 5 are contained within the primary nanopores or nanotubes of Analyte Spot 1. Secondary Nanoparticles 7 are formed inside and/or on the surface of secondary Nanotubes 5.

FIG. 9 shows top view of a single analyte spot which includes three sections respectively containing only primary nanostructures, primary nanostructures containing secondary nanorods, and primary nanostructures containing secondary nanoparticles. Section 8 contains only primary nanostructures, Section 9 contains primary nanostructures containing secondary nanorods such as shown in FIG. 3, and Section 10 contains primary nanostructures containing secondary nanoparticles such as shown in FIG. 7. This combination shown in FIG. 9 is only one possible combination of the number and type of sections in a given analyte spot. Many other combinations of secondary nanostructured materials described herein are possible to implement in a single localized analyte spot.

A method of using the disclosed LDI substrates to analyze samples using mass spectrometry is also disclosed herein. The LDI substrates are prepared as described above. One or more analytes may be placed in an analyte spot. The one or more analytes may then be ionized using a laser to generate one or more ionized analytes, according to standard LDI techniques known in the art. The one or more ionized analytes may then be introduced into a mass spectrometer for mass spectrometry analysis and a mass spectrum of the one or more ionized analytes may be obtained.

Experimental Procedures

The experimental procedures described below are intended to be merely exemplary, and should not be construed to limit the procedures by which the products described herein may be prepared. Modifications of these procedures may be readily apparent to a person skilled in the art, and such apparent modifications that are consistent with the principles set forth below may be made. Thus the products described may be made using procedures that are different from the procedures outlined below.

Preparation of Titanium Substrate with Nanotubular Anodic Titanium Oxide Analyte Spots

High purity Ti foil (99%, Alfa Aeser) was cleaned and degreased with acetone and ethanol. A photomask was used to define analyte spots with the proper design—for example, a substrate of 25 mm×75 mm, with 96 holes for analyte spots each 1-3 mm in diameter, was used. An industry standard photoresist such as AZ 1500 series (EMD) was applied to the Ti foil following standard procedures, exposed via photomask in UV light, developed per the photoresist manufacturer's recommended procedure, and rinsed in water. The masked Ti foil now had exposed analyte spots and the remainder of substrate covered with photoresist. The substrate was then subjected to two-step anodization. The anodization electrolyte solution was composed of ethylene glycol (reagent grade, Sigma Aldrich), 0.3 wt. % NH₄F (reagent grade, Sigma Aldrich), and 2 wt. % deionized water. Anodization of the masked substrate was performed with a Pt mesh as a counter electrode by applying 60V (Keithley Series 2268 850 W DC Power Supply) at room temperature for 2 hours. After removal from the electrolyte solution, the substrate was rinsed with water and then sonicated in 0.1M H₂SO₄ to remove the first layer of nanotubular TiO₂. After rinsing with ethanol and allowing to dry, the substrate was anodized for a second time in the same electrolyte, this time for 10 minutes to form the analyte spot containing titanium nanotubes. If metal was to be deposited into the resulting primary nanotubular structure, anodization voltage was successively reduced from 60V down to 10V at a ramp rate of 2-5V per minute at the end of the second anodization in order to reduce the oxide “barrier layer” thickness. The substrate was rinsed a final time in deionized water and allowed to dry. Removal of photoresist was performed by using standard photoresist stripping solutions recommended by the photoresist manufacturer or by carefully peeling from a corner of the substrate. The resulting substrate was used as is, or annealed for 1 hour at 450° C. in a standard muffle furnace. The nanotubular titanium oxide analyte spots were characterized by scanning electron microscopy.

Preparation of Aluminum with Nanoporous Anodic Aluminum Oxide Analyte Spots

High purity Al foil (99%, Alfa Aeser) was cleaned and degreased with acetone and ethanol. A photomask was used to define analyte spots with the proper design—for example, a substrate of 25 mm×75 mm, with 96 holes for analyte spots each 1-2.5 mm in diameter, was used. An industry standard photoresist such as AZ 1500 series (EMD) was applied to the Al foil following standard procedures, exposed via photomask in UV light, developed per the photoresist manufacturer's recommended procedure, and rinsed in water. The masked Al foil now had exposed analyte spots and the remainder of substrate covered with photoresist. The substrate was then subjected to two-step anodization in an electrolyte solution composed of 0.3M oxalic acid in water. Anodization of the masked substrate was performed with a Pt mesh as a counter electrode by applying 60V (Keithley Series 2268 850 W DC Power Supply) at room temperature for 2 hours. After removal from the electrolyte solution, the substrate was rinsed with water and then etched in a solution of 200 g/L chromic oxide (CrO₃) and 350 g/L of phosphoric acid (H₃PO₄) in water at a temperature of 75° C. After rinsing with water and allowing to dry, the substrate was anodized for a second time in the same oxalic acid electrolyte, this time for 10 minutes, to form nanoporous alumina in analyte spots. If metal was to be deposited into the resulting primary nanoporous structure, anodization voltage was successively reduced from 60V down to 10V at a ramp rate of 5-10V per minute at the end of the second anodization in order to reduce the oxide “barrier layer” thickness. The substrate was rinsed a final time in deionized water and allowed to dry. Removal of photoresist was performed by using standard photoresist stripping solutions recommended by the photoresist manufacturer or by carefully peeling from a corner of the substrate. The nanotubular aluminum oxide analyte spots were characterized by scanning electron microscopy.

Optional Electrodeposition of Metal into Nanoporous Structures

For both nanoporous aluminum oxide and nanotubular titanium oxide substrates, metals may optionally be deposited into the pores of the primary nanostructures to form metal nanowires. For example, to generate copper nanowires, a solution of 0.5M CuSO₄ and 0.1M H₂SO₄ in water was used at room temperature. With Pt mesh as the counter electrode, a constant cathodic current of −5 to −10 mA/cm² was applied for a duration of between about 50 ms and 5 seconds using a DC power supply, depending on the desired length of nanowires. To generate gold nanowires, the same procedure may be used, except with an aqueous solution containing 12 g/L of KAu(CN)₂ and 100 g/L of citric acid at 35° C.

### EXAMPLE 1

As described above, high purity Ti foil was cleaned and degreased with acetone and ethanol. AZ 1500 series photoresist was applied to the Ti foil substrate. A photomask with dimensions of 25 mm×75 mm and 96 analyte spot circular holes of 1.5 mm diameter each was placed on top of the photoresist. The substrate was exposed to UV light, and the photoresist was then developed to define the analyte spots. Two-step anodization was performed as described above. The first anodization was performed at 50V for 2 hours in an electrolyte solution of ethylene glycol (reagent grade, Sigma Aldrich), 0.3 wt. % NH₄F (reagent grade, Sigma Aldrich), and 2 wt. % deionized water. The substrate was rinsed and an initial nanotubular film of titanium oxide grown in the analyte spots was removed via sonicating in 0.1M H₂SO₄ for 5 minutes. The substrate was then anodized a second time in the same electrolyte at 50V for 40 minutes, and then rinsed in deionized water. After drying, the photoresist was peeled off. The nanotubular titanium oxide analyte spots were characterized by scanning electron microscopy, as shown in FIG. 11. The resulting substrate had 96 analyte spots containing nanotubular titanium oxide with a tube diameter of approximately 100 nm and a tube length of approximately 2500 nm, while the surrounding portion of the substrate did not have nanotube structure. Analytes of interest were placed onto analyte spots (20 μL of analyte solution per spot), and the substrate was placed into an instrument for LDI-MS analysis. Additional applications, such as growing a cell culture on the analyte spots followed by alternative analytical techniques such as, but not limited to, optical microscopy, electron microscopy, or spectroscopy is also envisioned.

### EXAMPLE 2

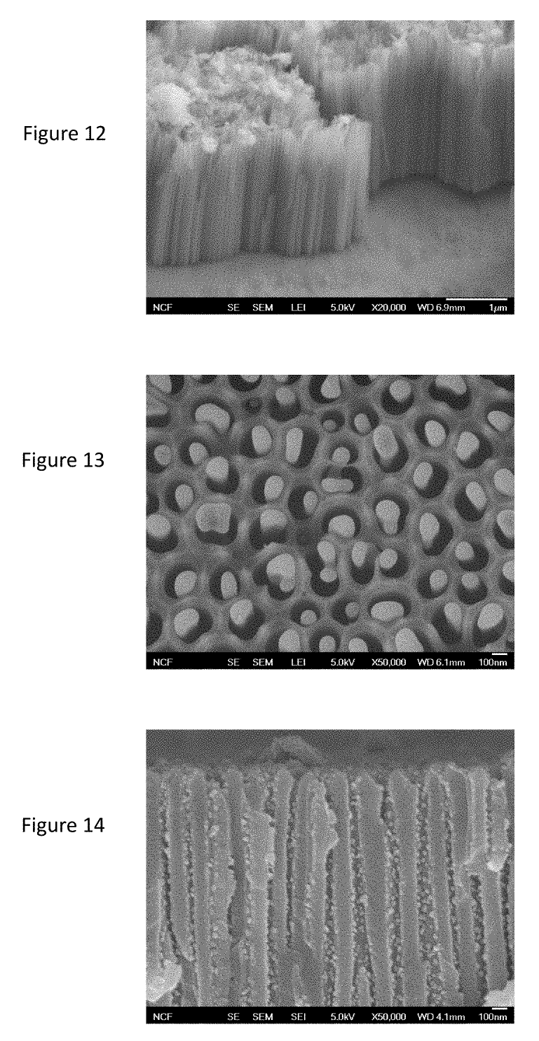

As described above, high purity Ti foil was cleaned and degreased with acetone and ethanol. AZ 1500 series photoresist was applied to the Ti foil substrate. A photomask with dimensions of 84 mm×128 mm and 384 analyte spot circular holes of 3 mm diameter each was placed on top of the photoresist. The substrate was exposed to UV light, and the photoresist was then developed to define the analyte spots. Two-step anodization was performed as described above. The first anodization was performed at 25V for 3 hours in an electrolyte solution of ethylene glycol (reagent grade, Sigma Aldrich), 0.3 wt. % NH₄F (reagent grade, Sigma Aldrich), and 2 wt. % deionized water. The substrate was rinsed and an initial nanotubular film of titanium oxide grown in the analyte spots was removed via sonication in 0.1M H₂SO₄ for 5 minutes. The substrate was then anodized a second time in the same electrolyte at 25V for 100 minutes, and then rinsed in deionizied water. In this case, the photoresist was not peeled off but rather left on the substrate. The nanotubular titanium oxide analyte spots were characterized by scanning electron microscopy, as shown in FIG. 12. The resulting substrate had 384 analyte spots containing nanotubular titanium oxide with a tube diameter of approximately 40 nm and a tube length of approximately 1500 nm, while the surrounding portion of the substrate did not have nanotube structure. Analytes of interest were placed onto analyte spots (3 μL of analyte solution per spot), and the substrate may be placed into an instrument for LDI-MS analysis.

### EXAMPLE 3

As described above, high purity Ti foil was cleaned and degreased with acetone and ethanol. AZ 1500 series photoresist was applied to the Ti foil substrate. A photomask with dimensions of 25 mm×75 mm and 96 analyte spot circular holes of 1.5 mm diameter each was placed on top of the photoresist. The substrate was exposed to UV light, and the photoresist was then developed to define the analyte spots. Two-step anodization was performed as described above. The first anodization was performed at 50V for 2 hours in an electrolyte solution of ethylene glycol (reagent grade, Sigma Aldrich), 0.3 wt. % NH₄F (reagent grade, Sigma Aldrich), and 2 wt. % deionized water. The substrate was rinsed and the initial nanotubular film of titanium oxide grown in the analyte spots was removed via sonication in 0.1M H₂SO₄ for 5 minutes. The substrate was then anodized a second time in the same electrolyte at 50V for 10 minutes, and then the anodization voltage was ramped down at a rate of 5V per minute to 10V and then held for 30 seconds at 10V. The substrate was then rinsed in deionized water. Electrodeposition of Cu nanorods was then performed following the procedure described above. The substrate was placed into a solution of 0.5M CuSO₄ and 0.1M H₂SO₄ at room temperature with a Pt mesh as the counter electrode. Cathodic current of −5 mA/cm² was applied for 0.5 seconds. The substrate was then rinsed in deionized water. After drying, the photoresist was peeled off. The nanotubular titanium oxide analyte spots were characterized by scanning electron microscopy. The resulting substrate had 96 analyte spots containing nanotubular titanium oxide with a tube diameter of approximately 100 nm and a tube length of approximately 600 nm. The nanotubular structure was filled with Cu nanorods with approximately the same diameter as the inside of the tubes (˜30 nm) and a length of approximately 300 nm, from the bottom of the tubes to approximately halfway up. The surrounding portion of the substrate did not have nanotube structure. Analytes of interest were placed onto analyte spots (15 μL of analyte solution per spot), and the substrate may be placed into an instrument for LDI-MS analysis.

### EXAMPLE 4

As described above, high purity Al foil was cleaned and degreased with acetone and ethanol. The Al substrate optionally included a thin layer of oxide formed by anodizing the substrate at 20V in a 3% aqueous solution of boric acid for 5 minutes to improve photoresist adhesion. A layer of AZ 1500 series photoresist was applied to the Al foil substrate. A photomask with dimensions of 84 mm×128 mm and 384 analyte spot circular holes of 2 mm diameter each was placed on top of the photoresist. The substrate was exposed to UV light, and the photoresist was then developed to define the analyte spots. Two-step anodization was performed as described above. The first anodization was performed at 80V in 0.3M oxalic acid at room temperature for 3 hours. After removal from the electrolyte solution, the substrate was rinsed with water and then etched for 30 minutes in a solution of 200 g/L of chromic oxide (CrO₃) and 350 g/L of phosphoric acid (H₃PO₄) in water at a temperature of 75° C. to remove the first layer of nanoporous alumina. After rinsing with water and allowing to dry, the substrate was anodized for a second time in the same oxalic acid electrolyte at 80V, this time for 20 minutes. After 20 minutes, the anodization voltage was ramped down at a rate of 10V per minute for 7 minutes. The substrate was then rinsed with deionized water, and electrodeposition of Au nanorods was performed. An aqueous solution containing 12 g/L of KAu(CN)₂ and 100 g/L of citric acid at 35° C. was used with a Pt mesh as the counter electrode. Cathodic current of −10 mA/cm² was applied for 2 seconds. The substrate was rinsed in deionized water, and the photoresist was peeled off. The nanoporous aluminum oxide analyte spots were characterized by scanning electron microscopy. The resulting substrate had 384 analyte spots containing nanoporous aluminum oxide with a pore diameter of approximately 80 nm and a pore length of approximately 1.5 μm, while the surrounding portion of the substrate did not have nanopore structure. The nanoporous aluminum oxide structure was filled with Au nanorods with approximately the same diameter as the pores (˜80 nm) and a length of approximately 1.2 μm, from the bottom of the pores to approximately ⅘ths of the way up. Analytes of interest were placed onto analyte spots (20 μL of analyte solution per spot), and the substrate was placed into an instrument for LDI-MS analysis.

### EXAMPLE 5

As described above, high purity Al foil was cleaned and degreased with acetone and ethanol. AZ 1500 series photoresist was applied to the Al foil substrate. A photomask with dimensions of 25 mm×75 mm and 96 analyte spot circular holes of 1 mm diameter each was placed on top of the photoresist. The substrate was exposed to UV light, and the photoresist was then developed to define the analyte spots. Two-step anodization was performed as described above. The first anodization was performed at 100V in 0.3M oxalic acid at room temperature for 3 hours. After removal from the electrolyte solution, the substrate was rinsed with water, and then etched for 45 minutes in a solution of 200 g/L of chromic oxide (CrO₃) and 350 g/L of phosphoric acid (H₃PO₄) in water at a temperature of 75° C. to remove the first layer of nanoporous alumina. After rinsing with water and allowing to dry, the substrate was anodized for a second time in the same oxalic acid electrolyte at 100V, this time for 35 minutes. After 35 minutes, the anodization voltage was ramped down at a rate of 10V per minute for 7 minutes. The substrate was then rinsed with deionized water, and electrodeposition of Au nanorods was performed. An aqueous solution containing 12 g/L of KAu(CN)₂ and 100 g/L of citric acid at 35° C. was used with a Pt mesh as the counter electrode. Cathodic current of −10 mA/cm² was applied for 5 seconds. The substrate was rinsed in deionized water, and the photoresist was peeled off. The substrate was then placed in 0.5M H₃PO₄ at 40° C. for 12 minutes to selectively etch some of the aluminum oxide, effectively increasing the primary nanopore diameter, but leaving the Au nanowires in place. The nanoporous aluminum oxide analyte spots with gold nanowires contained therein were characterized by scanning electron microscopy, as shown in FIG. 13. The resulting substrate had 96 analyte spots containing nanoporous aluminum oxide with a pore diameter of approximately 105 nm and a pore length of approximately 3 μm, while the surrounding portion of the substrate did not have nanopore structure. The nanoporous aluminum oxide structure was filled with Au nanorods with a diameter of approximately 80 nm, which was thus slightly narrower than the final pore diameter, and a nanorod length of approximately 2 μm, from the bottom of the pores to approximately ⅔rds of the way up. Analytes of interest were placed onto analyte spots (20 μL of analyte solution per spot), and the substrate may be placed into an instrument for LDI-MS analysis.

### EXAMPLE 6

As described above, high purity Al foil was cleaned and degreased with acetone and ethanol. AZ 1500 series photoresist was applied to the Al foil substrate. A photomask with dimensions of 25 mm×75 mm and 96 analyte spot circular holes of 1.5 mm each was placed on top of the photoresist. The substrate was exposed to UV light, and the photoresist was then developed to define the analyte spots. Two-step anodization was performed as described above. The first anodization was performed at 80V in 0.3M oxalic acid at room temperature for 3 hours. After removal from the electrolyte solution, the substrate was rinsed with water, and then etched for 45 minutes in a solution of 200 g/L of chromic oxide (CrO₃) and 350 g/L of phosphoric acid (H₃PO₄) in water at a temperature of 75° C. to remove the first layer of nanoporous alumina. After rinsing with water and allowing to dry, the substrate was anodized for a second time in the same oxalic acid electrolyte at 80V, this time for 35 minutes. After 35 minutes, the anodization voltage was ramped down at a rate of 10V per minute for 7 minutes. The substrate was then rinsed with deionized water, and the photoresist was peeled off. Then a new coat of photoresist was applied, and a new photomask was placed over the substrate. The second photomask had the same pattern as the first photomask, except that instead of 1.5 mm circles, it had a pattern of semi-circles, thus masking half of each analyte spot. After UV exposure and rinsing, electrodeposition of Au nanorods was performed. An aqueous solution containing 12 g/L of KAu(CN)₂ and 100 g/L of citric acid at 35° C. was used with a Pt mesh as the counter electrode. Cathodic current of −10 mA/cm² was applied for 5 seconds. The substrate was rinsed in deionized water, and the photoresist was peeled off. The nanoporous aluminum oxide analyte spots were characterized by scanning electron microscopy. The resulting substrate had 96 analyte spots containing nanoporous aluminum oxide with a pore diameter of approximately 80 nm and a pore length of approximately 3 μm, while the surrounding portion of the substrate did not have nanopore structure. Each analyte spot on the substrate was half filled with Au nanorods with a diameter of approximately 80 nm, and a length of approximately 2 μm, from the bottom of the pores to approximately ⅔rds of the way up. FIG. 9 shows a top schematic view of a single analyte spot with this type of segmented structure. Analytes of interest were placed onto analyte spots (20 μL of analyte solution per spot), and the substrate may be placed into an instrument for LDI-MS analysis.

### EXAMPLE 7

As described above, high purity Al foil was cleaned and degreased with acetone and ethanol. AZ 1500 series photoresist was applied to the Al foil substrate. A photomask with dimensions of 25 mm×75 mm and 96 analyte spot circular holes of 1.5 mm each was placed on top of the photoresist. The substrate was exposed to UV light, and the photoresist was then developed to define the analyte spots. Two-step anodization was performed as described above. The first anodization was performed at 100V in 0.3M oxalic acid at room temperature for 3 hours. After removal from the electrolyte solution, the substrate was rinsed with water, and then etched for 45 minutes in a solution of 200 g/L of chromic oxide (CrO₃) and 350 g/L of phosphoric acid (H₃PO₄) in water at a temperature of 75° C. to remove the first layer of nanoporous alumina. After rinsing with water and allowing to dry, the substrate was anodized for a second time in the same oxalic acid electrolyte at 100V for 30 minutes. The substrate was then rinsed with deionized water, and the pore diameter was increased to 100 nm by selective etching of a small amount of aluminum oxide off the nanopore walls in a solution of 0.5M H₃PO₄ in water at 35° C. for 16 minutes. The photoresist was then removed in a 70% solution of isopropanol in water. After rinsing and drying, Atomic Layer Deposition (ALD) of a secondary nanocoating of zinc oxide (ZnO) was performed using diethyl zinc (Zn(CH₂CH₃)₂) as the reagent for the first binary half-reaction and water vapor (H₂O) as the reagent for the second binary half-reaction, for a total of 80 ALD cycles, resulting in an estimated effective thickness of a secondary ALD nanocoating of 10 nm. The resulting localized nanoporous aluminum oxide analyte spots with a secondary ZnO nanocoating were characterized by scanning electron microscopy, as shown in FIG. 14. The resulting substrate had 96 analyte spots, each containing nanoporous aluminum oxide with a primary nanopore diameter of approximately 100 nm and nanopore length of approximately 5 μm, while the surrounding portion of the substrate did not have nanopore structure. Primary nanopores contained a discontinuous yet uniform secondary nanocoating of ZnO nanoparticles. Analytes of interest were placed onto analyte spots (20 μL of analyte solution per spot), and the substrate may be placed into an instrument for LDI-MS analysis.

The previous description of the disclosed embodiments is provided to enable any person skilled in the art to make or use the invention disclosed herein. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. All references cited herein are expressly incorporated by reference.

What is claimed is:

1. A substrate configured to receive one or more samples for analysis using laser desorption/ionization mass spectrometry comprising:
a. one or more localized analyte spots; and
b. a substrate base;
wherein the one or more analyte spots comprise primary nanostructures comprising at least one nanoporous or nanotubular metal oxide or semiconductor;
wherein the one or more analyte spots have a diameter of between about 0.1 mm and 10 mm;
wherein the substrate base comprises a non-nanoporous and non-nanotubular metal, metal oxide, or semiconductor; and
wherein the one or more analyte spots are more hydrophilic than the substrate base.

2. The substrate of claim 1, wherein the nanoporous or nanotubular metal oxide or semiconductor is selected from the group consisting of nanoporous aluminum oxide, nanotubular titanium oxide, and nanoporous silicon, and wherein the one or more analyte spots have a diameter of between about 0.2 mm and 5 mm.

3. The substrate of claim 1, wherein the nanoporous or nanotubular metal oxide or semiconductor is selected from the group consisting of nanoporous aluminum oxide, nanotubular titanium oxide, and nanoporous silicon, and wherein the nanoporous or nanotubular metal oxide or semiconductor comprises nanopores or nanotubes with a diameter of between about 1 nm and 1000 nm and a length of between about 10 nm and 10 μm.

4. The substrate of claim 2, wherein the nanoporous or nanotubular metal oxide or semiconductor comprises nanopores or nanotubes with a diameter of between about 1 nm and 1000 nm and a length of between about 10 nm and 10 μm.

5. The substrate of claim 3, wherein the nanoporous or nanotubular metal oxide or semiconductor comprises nanopores or nanotubes with a diameter of between about 10 nm and 250 nm.

6. The substrate of claim 5, wherein the nanoporous or nanotubular metal oxide or semiconductor comprises nanopores or nanotubes with a length of between about 250 nm and 2 μm.

7. The substrate of claim 4, wherein the nanoporous or nanotubular metal oxide or semiconductor comprises nanopores or nanotubes with a diameter of between about 10 nm and 250 nm.

8. The substrate of claim 7, wherein the nanoporous or nanotubular metal oxide or semiconductor comprises nanopores or nanotubes with a length of between about 250 nm and 2 μm.

9. The substrate of claim 1, wherein the analyte spots are coated with a thin surface of a deposit selected from the group consisting of metals and semiconductors.

10. The substrate of claim 3, wherein the primary nanostructures are partially or completely filled with secondary nanostructures comprising nanorods, nanoparticles, nanocoatings, or secondary nanotubes comprising one or more deposits selected from the group consisting of metals, metal alloys, metal oxides, and semiconductors.

11. The substrate of claim 10, wherein the primary nanostructures are partially or completely filled with nanorods, and wherein the diameter of the nanorods is substantially equal to or less than the diameter of the primary nanostructures.

12. The substrate of claim 10, wherein the primary nanostructures are partially or completely filled with nanoparticles.

13. The substrate of claim 10, wherein the primary nanostructures are partially or completely filled with secondary nanotubes.

14. The substrate of claim 10, wherein the nanorods, nanoparticles, nanocoatings, or secondary nanotubes comprise one or more deposits selected from the group consisting of copper, gold, silver, cobalt, and nickel, and alloys thereof.

15. The substrate of claim 3, wherein the primary nanostructures are conformally coated with one or more deposits selected from the group consisting of metals, metal alloys, metal oxides, and semiconductors to generate a conformal nanocoating, wherein the conformal coating may be continuous or discontinuous.

16. The substrate of claim 15, wherein the conformally coated primary nanostructures are partially or completely filled with nanoparticles comprising one or more deposits selected from the group consisting of metals, metal alloys, metal oxides, and semiconductors.

17. The substrate of claim 10, wherein the one or more analyte spots comprise two or more sections, wherein one or more sections are partially or completely filled with secondary nanostructures comprising nanorods, nanoparticles, nanocoatings, or secondary nanotubes and one or more sections are not filled with secondary nanostructures.

18. The substrate of claim 10 comprising two or more analyte spots comprising a first analyte spot and a second analyte spot;
wherein the first analyte spot comprises primary nanostructures that are partially or completely filled with a first set of secondary nanostructures comprising nanorods, nanoparticles, nanocoatings, or secondary nanotubes; and
wherein the second analyte spot comprises primary nanostructures that are not filled with secondary nanostructures or are partially or completely filled with a second set of secondary nanostructures having a different composition than the first set of secondary nanostructures.

19. A method of generating the substrate of claim 1 comprising the steps of:
a. obtaining a substrate base;
b. patterning the substrate base using a mask to define analyte spots of a desired shape and size to generate a patterned substrate;
c. anodizing the patterned substrate to form localized nanostructured analyte spots to generate a patterned and anodized substrate; and
d. removing the mask.

20. A method of analyzing a sample comprising one or more analytes using mass spectrometry, wherein the method comprises the steps of:
a. placing the one or more analytes in the one or more analyte spots of the substrate of claim 1;
b. ionizing at least one of the one or more analytes using a laser to generate one or more ionized analytes;
c. introducing the one or more ionized analytes into a mass spectrometer; and
d. obtaining a mass spectrum of the one or more ionized analytes.
